(19) United States
(12) Patent Application Publication
(10) Pub. No.: US 2004/0111506 A1
(43) Pub. Date: Jun. 10, 2004

(54) System and method for managing web utility services

(75) Inventors: Ashish Kundu, Orissa (IN); Vijay K. Naik, Pleasantville, NY (US); Mangala Gowri Nanda, New Delhi (IN); Giovanni Pacifici, New York, NY (US); Michael Joseph Spreitzer, Croton-on-Hudson, NY (US); Asser N. Tantawi, Somers, NY (US); Pradeep Varma, New Delhi (IN); Alaa S. Youssef, Valhalla, NY (US)

Correspondence Address: Anne Vachon Dougherty, 3137 Cedar Road, Yorktown Heights, NY, 10598, US

(73) Assignee: International Business Machines Corporation, Armonk, NY

(21) Appl. No.: 10/316,259

(22) Filed: Dec. 10, 2002

(51) Int. Cl. G06F 15/173; G06F 15/16

(52) U.S. Cl. 709/223; 709/203

(57) ABSTRACT

A performance management system and method for cluster-based web services comprising a gateway for receiving a user request, assigning the user request to a class, queuing the user request based on said class, and dispatching the user request to one of a plurality of server resources based on the assigned class and control parameters. The control parameters are continuously updated by a global resource manager which tracks and evaluates system performance.

### FIELD OF THE INVENTION

The invention relates to the performance management of cluster-based request/response web services, in the presence of Service Level Agreements (SLAs). More specifically, the invention relates to a system for enhancing web services to transparently provide management functions such as controlled sharing, monitoring, and service level agreement (SLA) based resource management.

### BACKGROUND OF THE INVENTION

The web services architecture attempts to provide means for offering computer applications as services over the Web. Such a service-oriented architecture deals with the advertisement and usage of services conforming to standardized interfaces. The web services model effectively defines the three roles of service provider, service broker, and service requester and their interactions through the three operations of publish, find, and bind. The operational characteristics of the web service are described in a standard language called Web Services Description Language (WSDL) which deals with the invocation of the web service. The actual implementation of the application providing the web service is hidden behind this standardized WSDL-based web service interface. The service provider publishes the web service in a widely accessible web services registry using standard Universal Description, Discovery, and Integration (UDDI) specifications. This UDDI registry is held and managed by a service broker. The service requester navigates through the UDDI registry to find a web service that fits a discovery criterion. Once a web service is found, the service requester accesses the WSDL description of the web service and uses the service through a process called binding. In such a process, the service requester utilizes a software client to send requests to the web service using a standard messaging protocol, called Simple Object Access Protocol (SOAP) that is based on the standard Extensible Markup Language (XML), and a standard transport protocol. A typical transport protocol is the Hypertext Transfer Protocol (HTTP). In answering a request, the web service sends back a response to the client. The format specifics of both requests and responses are obtained from the WSDL description of the web service. The specifications of the web services model are publicly available. Furthermore, there exist tools to simplify the building of web services and to provide a runtime environment for such services.

Today, the web services model defines various interfaces in a simple way that is based on ubiquitous protocols, language-independence, and standardized messaging. Such technical advantages, as well as a growing industrial support, have given rise to a proliferation of web services. However, most web services that are provided today are free and unmanaged. Nevertheless, due to the attractiveness of the web services model, it is envisioned that web services will play a key role in e-business. In this new business environment, services are expected to be dependable, secure, reliable, guaranteed, and profitable. A web service that satisfies such requirements will be hereinafter referred to as a web utility service (e-utility or utility, for short). Thus, the current web services model needs to be augmented with management functions such as usage metering, accounting, controlled access, dynamic resource allocation as well as service security, reliability and availability. The resulting utility model is realized in a web utility services platform (or utility platform, for short). The platform provides the necessary management functions to offer web services as utilities, such that the web services can be subscribed to, measured, and delivered both reliably and on demand. Such a platform manages the various phases in the life cycle of a utility such as deployment, provisioning, and invocation.

In the environment described above, a web service provider may provide multiple web services, each in multiple grades, and each of those to multiple customers. The provider will thus have multiple classes of web service traffic, each with its own characteristics and requirements. Performance management becomes a key problem, particularly when service level agreements (SLA) are in place. Service contracts between providers and customers include an SLA that specifies both performance targets, known as service level objectives (SLOs) or guarantees, and financial consequences for meeting or failing to meet those targets. An SLA may also depend on the level of load presented by the customer.

Despite the increasing awareness of the need for Quality-of-Service (QoS) support in middleware for distributed systems, and especially for web services, most of today's web servers do not provide the desired level of performance under overload situations, and provide no performance differentiation among the different classes of requests. As a result, SLA guarantees cannot be offered to clients.

Recently, session-based admission control for overload protection of web servers has gained some attention. In an article entitled “Session-Based Overload Control in QoS-Aware Web Servers”, IEEE INFOCOM 2002 (New York, N.Y., June 2002), authors Chen et al proposed using a dynamic weighted fair sharing scheduler to control overloads in web servers. The weights are dynamically adjusted, partially based on session transition probabilities from one stage to another, in order to avoid processing requests that belong to sessions likely to be aborted in the future. Similarly, in an article entitled “Application-aware Admission Control and Scheduling in Web Servers”, IEEE INFOCOM 2002, (New York, N.Y., June 2002), authors Carlstrom et al proposed using generalized processor sharing for scheduling requests, which are classified into multiple session stages with transition probabilities, as opposed to regarding entire sessions as belonging to different classes of service, governed by their respective SLAs.

Performance control of web servers using classical feedback control theory has been recently proposed. In an article entitled “Performance Guarantees for Web Server End-Systems: A Control-Theoretical Approach”, IEEE Transactions on Parallel and Distributed Systems, Vol. 13, No. 1 (January 2002), authors Abdelzaher et al used classical feedback control to limit utilization of a bottleneck resource in the presence of load unpredictability. Abdelzaher et al relied on scheduling in the service implementation to leverage the utilization limitation to meet differentiated response-time goals, using simple priority-based schemes to control how service is degraded in overload and improved in under load.

A common tendency across prior approaches is to tackle the problem at lower protocol layers, such as HTTP or TCP, with the need to modify the web server or the OS kernel in order to incorporate the control mechanisms. It is preferable, however, to operate at the SOAP protocol layer, which does not require changes to the server, and allows for finer granularity of content-based request classification.

Service differentiation in cluster-based network servers has been approached by physically partitioning the server farm into clusters, each serving one of the traffic classes. The clustering approach is limited, however, in its ability to accommodate a large number of service classes, relative to the number of servers. Fine-granularity resource partitioning is impossible with such techniques. Lack of responsiveness due to the nature of the server transfer operation from one cluster to another is a problem in such systems.

Another problem encountered by server farms is workload balancing. Prior art systems focus primarily on monitoring and reacting to overload indicators, without attempting to build a performance model for the controlled system. It is preferable, however, to focus on optimizing business objectives through the use of a queuing-based performance model. In an article entitled “Managing Energy and Server Resources in Hosting Centers”, Proceedings of 18th ACM Symposium on Operating System Principles, pages 103-116 (October 2001), by Chase et al, techniques (e.g., cluster reserves and resource containers) are suggested for partitioning server resources and quickly adjusting the proportions for cluster-wide optimization. Chase, et al also add terms for the cost (due, e.g., to power consumption) of utilizing a server, and use a more fragile solution technique.

In an article entitled “Enforcing Resource Sharing Agreements among Distributed Server Clusters”, Proceedings International Parallel and Distributed Processing Symposium, IPDPS 2002 (Ft. Lauderdale, Fla., April 2002), pp. 501-510, authors Zhao and Karamcheti propose a distributed set of queuing intermediaries with non-classical feedback control that maximizes a global objective. The Zhao, et al management technique concerns resources, assuming a relation to performance results has already been established, but does not decouple the global optimization cycle from the scheduling cycle.

The notion of using a utility (or class objective) function and applying a combining function (e.g., maximizing a sum or minimizing cost) to the utility functions for various classes of service has also been used in QoS of communication services. There the problem is to allocate bandwidth to the various classes of service so as to maximize gain and/or achieve fairness. In such analyses, the utility function is defined in terms of bandwidth allocated (i.e. resources), and is typically a logarithmic function. It is desirable, however, to define a class objective function in terms of the service performance level relative to the guaranteed service level objective. Thus, it is possible to express the business value of meeting the service level objective as well as deviating from it. Further, the effect of the amount of allocated resources on performance level is separated from the business value objectives.

It is therefore an object of the present invention to provide a method of managing a plurality of servers to service multiple classes of request/response web services traffic.

Another object of this invention is to provide a process for assigning requests to classes in accordance with said the request's attributes.

Yet another object of this invention is to provide a process for inserting each request into one of several queues corresponding to its assigned class.

Still another object of this invention is to provide a method for selecting requests to be executed from a queue, based on control parameters.

Another object of this invention is to provide a process for forwarding a request to a selected server, transparently to the client requesting the request.

A further object of this invention is to provide a method for repeatedly adjusting control parameters based on measurements of offered load and system performance.

### SUMMARY OF THE INVENTION

The foregoing and other objects are realized by the present invention which provides a performance management system for cluster-based web services. The system Supports multiple classes of web services traffic and continuously maximizes a given cluster objective in the face of fluctuating load. The cluster objective is a function of the performance delivered to the various classes, and leads to differentiated service, with average response time being the performance metric. The management system is transparent: it requires no changes in the client code, the server code, or the network interface between them. The system performs three performance management tasks including resource allocation, load balancing, and server overload protection. Two nested levels of management mechanism include an inner level, which centers on queuing and scheduling of request messages, and an outer level, which is a feedback control loop that periodically adjusts the scheduling weights and server allocations of the inner level. The feedback controller is based on an approximate first-principles model of the system, with parameters derived from continuous monitoring. The performance management system and method for cluster-based web services comprising a gateway for receiving a user request, assigning the user request to a class, queuing the user request based on said class, and dispatching the user request to one of a plurality of server resources based on the assigned class and control parameters. The control parameters are continuously updated by a global resource manager which tracks and evaluates system performance.

### BRIEF DESCRIPTION OF THE FIGURES

The foregoing and other objects, aspects, and advantages will be better understood from the following non-limiting detailed description of preferred embodiments of the invention with reference to the drawings that include the following:

FIG. 1 is a block diagram of the present inventive system;

FIG. 2 illustrates the components of the gateway of the present invention;

FIG. 3 provides a process flow for operation of the gateway of FIG. 2; and

FIG. 4 depicts the input and output of the Global Resource Manager.

### DETAILED DESCRIPTION OF THE INVENTION

A Service Level Agreement (SLA) based performance management system for web services is detailed herein including reactive control mechanisms to handle dynamic fluctuations in service demand while keeping SLAs in mind. The mechanisms dynamically allocate resources among the classes of traffic, balance the load across the servers, and protect the servers against overload, in a way that maximizes a given cluster objective function to produce differentiated service.

The inventive cluster objective function is a composition of two kinds of functions, both given by the service provider. First, for each traffic class, there is a class-specific objective function of performance. Second, there is a combining function that combines the class objective values into one cluster objective value. This parameterization by two kinds of objective functions gives the service provider flexible control over the trade-offs made in the course of service differentiation. In general, a service provider is interested in profit (which includes cost as well as revenue) as well as other considerations (e.g., reputation, customer satisfaction). In a straightforward application, a class objective function directly reflects the terms of the SLA and computes the net revenue that results from a given level of performance. However, a class objective function may also include other considerations, when dealing with agreements with for-profit and nonprofit businesses, as well as service centers within larger organizations, such as the aforementioned customer satisfaction.

The inventive architecture is organized into two levels: (i) a collection of in-line mechanisms that act on each connection and each request, and (ii) a feedback controller that tunes the parameters of the in-line mechanisms. The in-line mechanisms consist of connection load balancing, request queuing, request scheduling, and request load balancing. The feedback controller periodically sets the operating parameters of the in-line mechanisms so as to maximize the cluster objective function. The feedback controller uses a performance model of the cluster to solve an optimization problem. The feedback controller continuously adjusts the model parameters using measurements of actual operations.

The invention will be described using Simple Object Access Protocol (SOAP) based web services and using statistical abstracts of SOAP response times as the characterization of performance. A customer may care about response times at various levels of abstraction, with business processes, as well as SOAP transactions, being characterized as having requests and responses. In general, processing may involve non-computational resources (e.g., people, weather, trucks). The present technique and result can be generalized in a straightforward manner to any technology and level of abstraction with well-defined requests and response times that are primarily dependent on computational resources. Due the fact that implementation of the present invention has no functional impact on the service customers or service implementation, such that it is a transparent management technique that requires no changes to the client code, the server code, or the network protocol between them, it is widely applicable.

The inventive system allows service providers to offer and manage Service Level Agreements (SLA) for web services. An SLA specifies both performance targets, known as service level objectives (SLOs), and financial consequences for meeting or failing to meet those targets. An SLA may also define the maximum level of traffic that a customer can present to the system. The service provider can offer each web service in different SLA grades, with each grade defining a specific set of SLA parameter values. For example, the stockUtility service could be offered in either Gold, Silver, or Bronze grade, with each grade differentiated by SLO, base price, and performance penalty. A prototypical grade will say that the service customers will pay $10 for each month in which they requests less than 1,000,000 transactions, with a guarantee of a 95th percentile response time of less than 5 seconds, and $5 for each month of lesser service.

Using a configuration tool the service provider will define the number and parameters of each service grade. Using a subscription interface, users can register with the system and subscribe for services. At subscription time each user will select a specific offering and associated SLA grade. The service provider uses the configuration tool to create a set of traffic classes and to map a <user, service, operation, grade> tuple into a specific traffic class (or “class” hereinafter). The service provider assigns a specific response time target to each traffic class. For example, if the parameter is the average request response time, a target value is specified for each traffic class. The management system allocates resources to traffic classes with a given assumption that each traffic class has a homogenous service execution time.

The reason for a mapping function stems from several factors. For example, each <service, grade> can be mapped into a separate class. Further, a class that corresponds to a particular contract can be created to handle traffic from that specific customer in a specific way. One other reason for introducing the concept of traffic classes is to discriminate on individual operations, for services that have operations with widely differing execution time characteristics. For example, the stockUtility service may support the operations getQuote( ) and buyshares( ). The fastest execution time for getQuote( ) could be 10 ms while the buyshares( ) cannot execute faster that 1 sec. In such a case, the service provider would map these operations into different classes with different sets of response time goals.

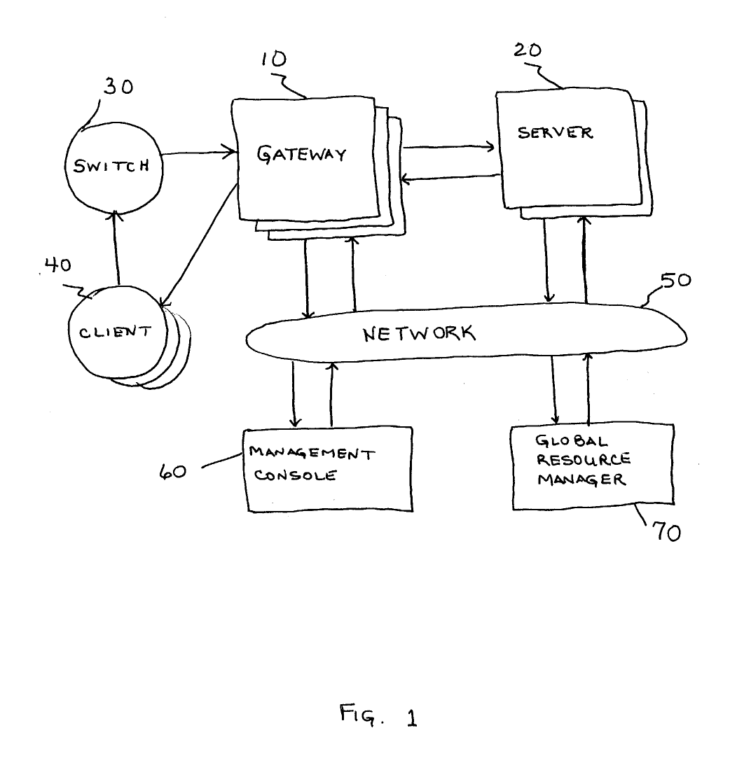

The overall system architecture is described in FIG. 1. The main components are: a set of gateways 10, a set of server nodes 20, a global resource manager 70, a control network 50 and a management console 60. Clients 40 connect to gateways 10 through switches 30.

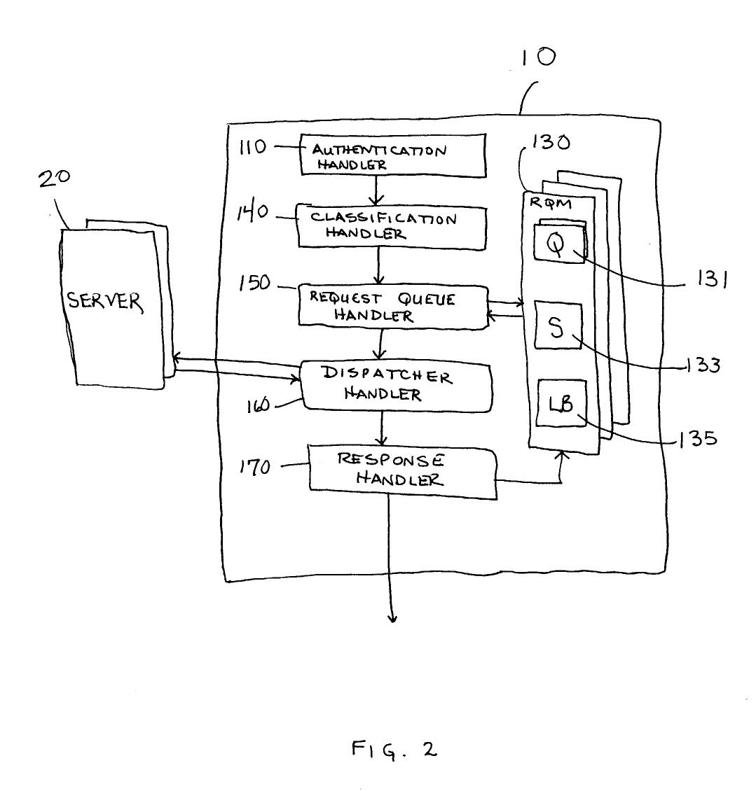

The gateways 10 implement the key features of the present architecture. The gateways 10 control the amount of resources allocated to web service requests by queuing and dispatching each SOAP request. A switch 30, such as a layer-4, load balancer switch, preferably is used to spread traffic from service clients 40 across the multiple gateways 10 to achieve scalability and reliability. Each gateway 10 implements a set of queues, a scheduler, and a load balancer, as detailed further below with reference to FIG. 2. The gateway 10 implements a queue for each traffic class. The scheduler selects requests for execution using a well-known weighted round-robin scheduling discipline. The load balancer selects the server 20 that will execute the request in accordance with known load balancing mechanisms, such as weighted round robin load balancing. The load balancer enforces limits on the number of concurrent requests executing on each server 20. Assuming that the optimal concurrency level NS for each server S is known, the number of concurrently executing requests that yields optimal throughput is defined with NS. The concurrency level on each server 20 is maintained at or below the optimum. This mechanism prevents a server 20 from becoming overloaded and provides finer control over the response time, since requests wait in the queues rather than competing for resources on the servers 20.

The Global Resource Manager 70 (GRM) adjusts the control settings, or control parameters, including the scheduling weights used by the scheduler and the concurrency limits used by the load balancer, taking into account current measurements of the offered load, server utilization, and server performance. Each gateway 10 makes local resource allocation decisions and broadcasts measurements of the offered load and server performance, gathered at its registers (not shown). Monitors on the servers 20 broadcast utilization measurements, either periodically or upon detection of an overload condition. The GRM 70 receives this information, performs an optimization operation, and then publishes the control settings. Each gateway's scheduler constantly monitors the Control Network 50 to receive and implement new control settings from the GRM 70.

The Control Network 50 implements a publish/subscribe messaging system, which is used to distribute control information among the servers 20, the GRM 70 and the gateways 10. The Management Console 60 offers an integrated GUI to the management system. It displays many of the values distributed over the control network 50, and allows “manual override” of the GRM 70. In addition, it displays and allows override of certain configuration parameters.

The Server machines 20 run the application-level service logic. In the simplest configuration, each service is deployed on each server machine 20. In a more complex configuration, subsets of the services (or even grades of services) run on subsets of the servers 20, whereby the server machines 20 are divided into disjoint pools or partitions of server resources.

The gateway 10 functions may be run on dedicated machines, or one on each server machine 20. The second approach has the advantage that it does not require a sizing function to determine how many gateways are needed, and the disadvantage that the server machines 20 are subjected to load beyond that explicitly managed by the gateways 10.

FIG. 2 illustrates the components of gateway 10. A representative implementation of the inventive gateway uses Axis™ to implement the gateway components and some of the mechanisms on Axis handlers, which are generic interceptors in the stream of message processing. Axis handlers can modify the message, and can communicate out-of-band with one another via an Axis message context associated with each SOAP invocation (request and response).

The Request Queue Manager (RQM) 130, implements a set of queues 131, the scheduler 133, and the load balancer 135, for its pool or partition. There is one queue per traffic class offered from the RQM and all traffic from a single queue will go to one partition of server resources. An RQM 130 derives and publishes certain performance measures and internal statistics, including but not limited to arrival rate per class, number of queued requests per class, response time per class, and service time. An RQM's scheduler runs when two conditions exist, a non-empty queue (i.e., a waiting request) and availability of at least one server resource, to pick the next request to execute. The scheduler chooses a queue from one of the RQM's queues using a weighted round robin scheme and then picks the next request in that queue. The weighted round robin scheme is work-conserving since it always chooses a non-empty queue if there is at least one. An RQM's scheduler in the gateway is given a list of the RQM's servers, including the following information for each server S:

N(G,S) which is the maximum number of requests that may be outstanding from G to S;

A set of round-robin weights w(G,C), one for each traffic class C handled by the RQM; and

Protocol type and endpoint address used in contacting the server. Examples of protocol types include HTTP and JMS; and, examples of address include the HTTP URL or the pub/sub topic.

The RQM 130 makes sure that each server S 20 does not execute more than N(G,S) requests. By controlling the maximum number of requests being served simultaneously on each server 20, the service time can be controlled to present each server from becoming overloaded. The RQM 130 constantly tracks the number of requests currently being executed for it by each server node. When a request completes, the response handler 170 notifies the RQM. The RQM 130 runs its scheduler and selects a request for dispatching when it has at least one non-empty queue and there is at least one server S 20 to which the RQM has less than N(G,S) outstanding requests. The dispatcher handler forwards the request to the selected server.

The Classification Handler (CH) 140 determines the traffic class and server or service pool that has been identified for handling the traffic class. The mapping function uses the request meta-data (user id, subscriber id, service name, etc.) found in a request to access the user's subscription information. The CH 140 uses the user and SOAP action fields in the HTTP headers as inputs and reads the mappings from the stored configuration files. A more sophisticated database or directory could be used, preferably one which already contains the user authentication and authorization information. It is preferable to avoid parsing the incoming SOAP request to minimize overhead.

The Request Queue Handler (RQH) 150 informs the RQM 130 about the arrival of each new request. The RQM 130 delays the request thread until it is scheduled for execution and then releases it to the Request Queue Handler 150 which, in the detailed Axis implementation, updates the Axis message context with the identity of the server to receive the request.

The Dispatch Handler 160 implements the RQM's routing decision. It routes the request to the server machine, using the protocol determined by the process above.

The Response Handler 170 reports to the relevant RQM upon the completion of the request's processing. The RQM 130 uses this information to keep an accurate count of the number of requests currently executing for it on each server. The RQM 130 also uses this information to measure performance data such as service time.

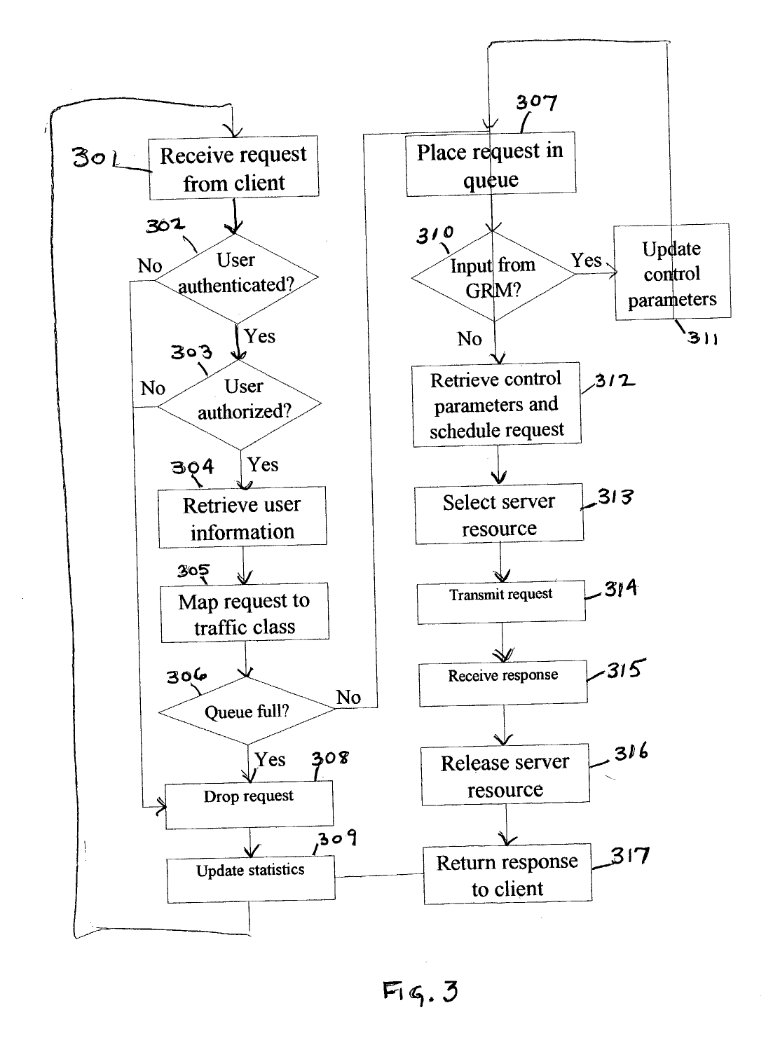

The process flow for the gateway will now be detailed with specific reference to FIG. 3. When a client request arrives at step 301, the gateway 10 first performs authentication at 302 and access control at 303. Authentication refers to matching username and passwords against the list of authorized users. Access control refers to verifying that the authenticated user has a valid subscription to the requested web service. Next, the gateway performs classification at step 304 by retrieving the parameters associated with this user subscription, including the traffic class for requests from this user. At step 305, the gateway performs mapping of the request to the specific traffic class, followed by determining if the queue which corresponds to the traffic class has room for the request, at 306. If the queue is not full, the request is placed into the queue at step 307. If, however, the queue is full, the request is dropped at 308 and the statistics for the RQM are updated at 309.

Once the request has been queued, it remains in the queue until the scheduler selects the request. The scheduler schedules the request in accordance with a weighted round robin scheduling discipline, using control parameters (including class scheduling weights and server concurrency load) received from the Global Resource Manager. Step 360 shows a decision box wherein it is determined whether any new input has been received from the GRM. If new input has been sent from the GRM, as determined at 310, the RQM scheduler updates its stored control parameters, at 311, and then proceeds to step 312 at which its stored control parameters are retrieved and the request is scheduled, followed by a server being selected for the request at 313. Once the request has been transmitted to the server, at 314, the RQM waits for a response from the server indicating that the request has been handled. When the response is received at 315, the server resource is released at 316, the response is returned to the requesting client at 317, and the gateway updates its registers at 309 in order to track server load, etc.

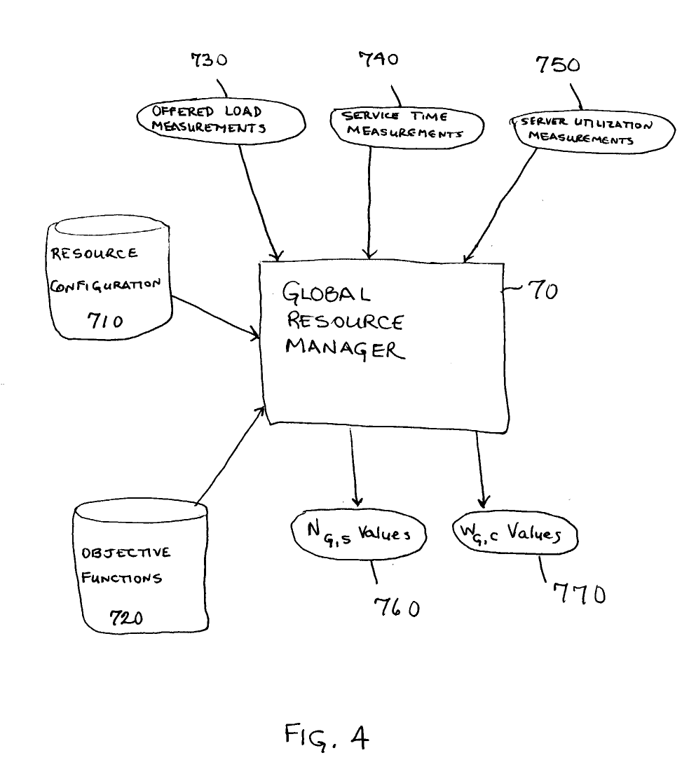

FIG. 4 provides a logical diagram of the inputs and outputs of the Global Resource Manager 70. The Global Resource Manager (GRM) 70 participates in resource allocation, server overload protection, and load balancing by updating the control values that parameterize the behavior of the gateways. In each periodic run, and/or in response to significant load or configuration changes, the GRM 70 examines the latest measurements and computes new control values. FIG. 4 shows the GRM inputs and outputs. The real-time dynamic measurements consist of measurements of the offered workload 730, service time 740, and server utilization 750. The measurements are provided over network 50 from the gateways and servers. In addition to real-time dynamic measurements, the GRM 70 uses resource configuration information 710 and the cluster objective function 720 which are stored values that are representatively shown in DASDs. The cluster objective function 720 consists of a set of class objective functions plus one combining function, which has been predefined by the service provider. Each class objective function maps the performance for a particular traffic class into some scalar value of that performance. A class objective function encapsulates a service level objective and encapsulates business judgments about the value of missing or exceeding the target by various amounts. A combining function combines the class objective values into one cluster objective value.

The GRM 70 analyzes its inputs, creates a queuing model of the system, and calculates an optimization algorithm to maximize the cluster objective function over the next control period. The optimization problem yields the control values, N(G,S) 760 and w(G,C) 770 discussed above, for every gateway G, server S, and traffic class C.

While the invention has been described with reference to several preferred embodiments, it will be understood by one having skill in the art that modifications can be made without departing from the spirit and scope of the invention as set forth in the appended claims.

Having thus described the invention, what is claimed is:

1. A method of managing a plurality of server resources to service multiple classes of user requests, each request having request attributes, said method comprising the steps of:
a) assigning each of a plurality of requests to one of said classes in accordance with the request attributes;
b) inserting each request into one of a plurality of queues corresponding to its assigned class;
c) selecting a next request of said requests to be executed from one of said queues, said one queue being selected based on control parameters;
d) selecting one of said server resources for handling said next request; and
e) forwarding said next request to a selected one of said server resources, transparently to any client requesting said next request.

2. The method of claim 1 further comprising monitoring a plurality of system performance measures and repeatedly adjusting said control parameters based on said system performance measures.

3. The method of claim 2 wherein said plurality of system performance measures comprise number of queued requests per class, response time per class, and server resource performance.

4. The method of claim 1 further comprising creating said classes based on projected use of server resources.

5. The method of claim 1 wherein user information is stored for subscribing users and wherein said assigning request to one of said classes comprising the steps of:
a) determining the user identity from said request;
b) accessing said stored user information; and
c) assigning a request to a class indicated in said stored user information.

6. The method of claim 5 further comprising authenticating said user and verifying user access to service.

7. The method of claim 1 wherein said control parameters include scheduling weights.

8. The method of claim 1 wherein said control parameters include concurrency limits for said server resources.

9. A system for managing a plurality of server resources to service multiple classes of user requests comprising:
a) at least one receiving component for receiving user requests; and
b) at least one gateway for assigning requests to classes, for queuing requests according to assigned classes in a plurality of gateway queues; and for dispatching request to server resources in accordance with assigned class and control parameters.

10. The system of claim 9 further comprising a global manager component for adjusting said control parameters.

11. The system of claim 9 further comprising a plurality of registers for tracking system performance.

12. The system of claim 9 wherein said gateway further comprises a dispatch handler for transmitting requests to server resources.

13. The system of claim 9 wherein said gateway comprises a classification handler for assigning requests to classes.

14. The system of claim 13 further comprising at least one storage location for maintaining stored user information and wherein said classification handler is adapted to access stored user information and assign request to classes based on said stored user information.

15. The system of claim 9 wherein said gateway further comprises at least one authentication component for authenticating a user.

16. The system of claim 9 wherein said gateway further comprise at least one access control component for verifying user access to service.

17. The system of claim 9 wherein said gateway comprises a scheduling component for selecting a next request to be executed from one of said queues.

18. The system of claim 9 wherein said gateway further comprises a dispatching component for selecting one of said server resources to execute a next request.

19. The system of claim 10 further comprising a publish and subscribe network connecting said gateway, said server resources, and said global manager component.

20. A program storage device readable by machine tangibly embodying a program of instructions executable by the machine for implementing a method for managing a plurality of server resources to service multiple classes of user requests, each request having request attributes, said method comprising the steps of:
a) assigning each of a plurality of requests to one of said classes in accordance with the request attributes;
b) inserting each request into one of a plurality of queues corresponding to its assigned class;
c) selecting a next request of said requests to be executed from one of said queues, said one queue being selected based on control parameters; and
d) selecting one of said server resources for handling said next request.
